(19) United States
(12) Patent Application Publication
(10) Pub. No.: US 2026/0195116 A1
(43) Pub. Date: Jul. 9, 2026

(54) SOFTWARE UPDATING SYSTEM, SOFTWARE UPDATING DEVICE, SOFTWARE UPDATING METHOD, AND STORAGE MEDIUM

(71) Applicant: HONDA MOTOR CO., LTD., TOKYO (JP)

(72) Inventor: Yujiro KOMIYAMA, TOKYO (JP)

(21) Appl. No.: 19/434,263

(22) Filed: Dec. 29, 2025

(30) Foreign Application Priority Data
Jan. 6, 2025 (JP) 2025-001674

(51) Int. Cl. G06F 8/65

(52) U.S. Cl. CPC G06F 8/65

(57) ABSTRACT

A software updating system includes a vehicle, a server device that is capable of communicating with the vehicle via a network, a transmission processing unit configured to execute a transmission process for carrying out transmission of data to the server device, and an update processing unit configured to execute, in response to completion of the transmission process by the transmission processing unit, execute a software updating process for an electronic control unit that is provided in the vehicle, wherein, in the case that the transmission process has timed out due to a communication condition being unsatisfactory, the update processing unit executes the software updating process without waiting for the completion of the transmission process.

### CROSS-REFERENCE TO RELATED APPLICATIONS

This application is based upon and claims the benefit of priority from Japanese Patent Application No. 2025-001674 filed on Jan. 6, 2025, the contents of which are incorporated herein by reference.

### BACKGROUND OF THE INVENTION

### Field of the Invention

The present disclosure relates to a software updating system, a software updating device, a software updating method, and a storage medium.

### Description of the Related Art

In JP 2022-154449 A, a software management system (a software updating system) is disclosed. In such a software management system, a process related to updating of the software is carried out in an OTA (Over the Air) manner.

### SUMMARY OF THE INVENTION

There is a long awaited need for a more satisfactory software updating system, a more satisfactory software updating device, a more satisfactory software updating method, a program for causing a computer to execute a more satisfactory software updating method, and a computer readable non-transitory storage medium in which there is stored a program for causing a computer to execute a more satisfactory software updating method.

The present disclosure has the object of overcoming and solving the aforementioned problem.

A first aspect of the present disclosure is characterized by a software updating system comprising a vehicle and a server device configured to communicate with the vehicle via a network, the software updating system including a transmission processing unit configured to execute a transmission process to carry out transmission of data to the server device, an update processing unit configured to execute, in response to completion of the transmission process by the transmission processing unit, a software updating process for an electronic control unit that is provided in the vehicle, wherein in the case that the transmission process times out due to a communication condition being unsatisfactory, the update processing unit executes the software updating process without waiting for the completion of the transmission process.

A second aspect of the present disclosure is characterized by a software updating system comprising a vehicle and a server device configured to communicate with the vehicle via a network, the software updating system including a power mode switch configured to switch a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, a transmission processing unit configured to sequentially execute a plurality of transmission processes for carrying out transmission of data to the server device, and an update processing unit configured to execute a software updating process for an electronic control unit that is provided in the vehicle, wherein in response to the power mode being the second mode, and further all of the plurality of transmission processes being completed without a timeout, the update processing unit executes the software updating process, and in the case that the power mode is the second mode and further any one of the plurality of transmission processes times out, the update processing unit executes the software updating process without waiting for the transmission processing unit to complete all of the plurality of transmission processes.

A third aspect of the present disclosure is characterized by a software updating device in the software updating system according to the first aspect, wherein the software updating device includes the transmission processing unit and the update processing unit.

A fourth aspect of the present disclosure is characterized by a software updating method for carrying out a software updating process for an electronic control unit that is provided in a vehicle, the software updating method including a transmission processing step of executing a transmission process for carrying out transmission of data to a server device configured to communicate via a network, and an update processing step of executing the software updating process in response to completion of the transmission process, wherein in the case that the transmission process times out due to a communication condition being unsatisfactory, the software updating process in the update processing step is executed without waiting for the completion of the transmission process.

A fifth aspect of the present disclosure is characterized by a program that causes a computer to execute the software updating method according to the fourth aspect.

A sixth aspect of the present disclosure is characterized by a computer readable non-transitory storage medium that stores the program according to the fifth aspect.

According to the present disclosure, it is possible to provide a more satisfactory software updating system, a more satisfactory software updating device, a more satisfactory software updating method, a program for causing a computer to execute a more satisfactory software updating method, and a computer readable non-transitory storage medium in which there is stored a program for causing a computer to execute a more satisfactory software updating method.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a software updating system according to one embodiment;

FIG. 2 is a flow diagram of a software updating process according to the one embodiment;

FIG. 3 is a flowchart showing a transmission control carried out by the software updating device according to the one embodiment;

FIG. 4 is a flowchart showing a software updating control carried out by the software updating device according to the one embodiment;

FIG. 5 is a flowchart showing the software updating control carried out by the software updating device according to the one embodiment;

FIG. 6 is a diagram providing a description concerning operations of the software updating device;

FIG. 7 is a diagram providing a description concerning operations of the software updating device; and

FIG. 8 is a diagram providing a description concerning operations of the software updating device.

### DETAILED DESCRIPTION OF THE INVENTION

Conventionally, updating of software for an electronic control unit (hereinafter referred to as an ECU) that is installed in a vehicle has been carried out at a dealer or the like. In recent years, a vehicle that is capable of carrying out updating of software of an ECU by means of an OTA (Over the Air) manner in which wireless communication is used has become available on the market, and in such a vehicle, it is possible to carry out updating of the software of the ECU without having to take the vehicle to a dealer or the like.

In a software updating process performed by means of an OTA manner, in the process of carrying out activation of the software, there are cases in which the ECU may need to be rebooted. Therefore, activation of the software is carried out while the vehicle is parked and a driving source such as an engine or a drive motor or the like is stopped.

In a period during which application of the software is carried out, a state is brought about in which the drive source is incapable of being started, and the vehicle cannot be driven. The period during which the drive source cannot be started due to the activation of the software is referred to as downtime.

Prior to the activation of the software being started, a confirmation process is carried out to confirm with the user whether or not the user is willing to approve the downtime. In the confirmation process, downtime approval information is displayed on a display unit such as an in-vehicle infotainment (hereinafter referred to as IVI) system or the like.

In the case that the user has approved the downtime, a transmission process is carried out in which an event log or the like containing information indicating that approval for the downtime has been obtained is transmitted from the vehicle to a server device. After the transmission process is completed, activation of the software is carried out.

In the case that from a point in time at which the user has approved the downtime, the activation of the software is not completed within a predetermined time period (hereinafter referred to as a downtime maximum time period), the activation will be canceled. In accordance with this feature, a situation in which the vehicle continues to be incapable of traveling for a prolonged period of time is suppressed.

In the case that the communication condition at a location in which the vehicle is parked is not satisfactory, the downtime maximum time period may be reached prior to the transmission process being completed, and there is a concern that the activation may not take place. Further, even if the transmission process is completed prior to the downtime maximum time period being reached, there is a concern that the transmission time requires some time and thus sufficient time cannot be taken for the activation from the point in time at which the transmission process is completed until the downtime maximum time period is reached, resulting in that the activation is canceled.

According to the present disclosure, even in the case that the communication condition is not satisfactory, the activation of the software can be satisfactorily carried out.

### Embodiment

A description will be given below with reference to the drawings concerning a software updating system, a software updating device, a software updating method, and a computer-readable non-transitory storage medium according to an embodiment. The program (a computer program, computer software) according to the present embodiment may also be referred to as a computer program product. The computer program product is not limited to being a computer program that is stored in a storage medium, but may also include a computer program that is transmitted, distributed, or downloaded via the Internet or the like.

### Configuration of Software Updating System

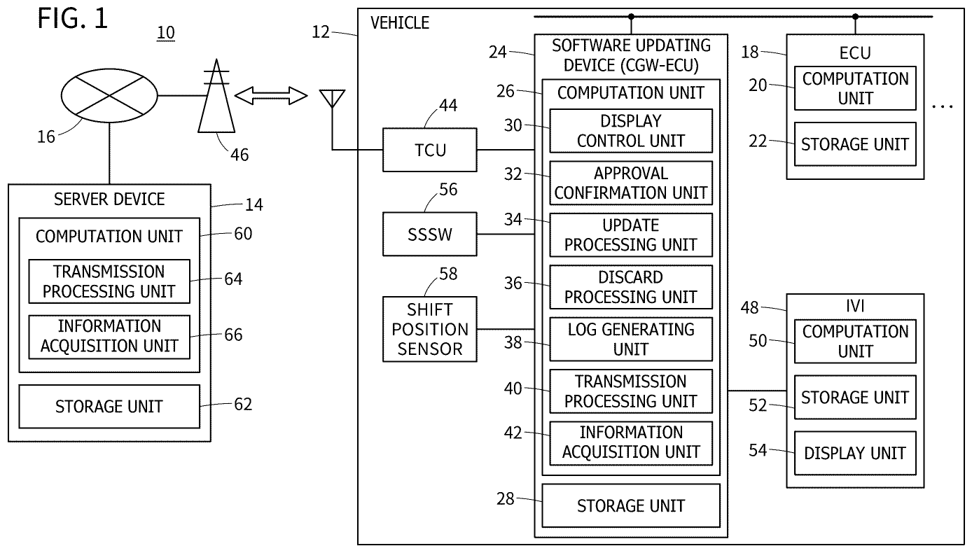

FIG. 1 is a schematic diagram showing a software updating system 10 according to one embodiment. The software updating system 10 comprises a vehicle 12 and a server device 14. The server device 14 is capable of communicating with the vehicle 12 via a network 16.

A plurality of ECUs 18 are installed in the vehicle 12. Each of the ECUs 18 carries out a control in order to realize a driving function and other functions of the vehicle 12. Each of the ECUs 18 includes a computation unit 20 and a storage unit 22. The computation unit 20, for example, is a processor such as a CPU (Central Processing Unit) or a GPU (Graphics Processing Unit) or the like. At least a portion of the computation unit 20 may be realized by an integrated circuit such as an ASIC (Application Specific Integrated Circuit), an FPGA (Field-Programmable Gate Array), or the like. At least a portion of the computation unit 20 may be realized by an electronic circuit including a discrete device.

The storage unit 22 is a computer readable non-transitory tangible storage medium. The storage unit 22 is constituted by a non-illustrated volatile memory, and a non-illustrated non-volatile memory. The volatile memory, for example, is a RAM (Random Access Memory) or the like. The non-volatile memory, for example, is a ROM (Read Only Memory) or a flash memory or the like. Data and the like are stored, for example, in the volatile memory. A program, a table, a map, and the like are stored, for example, in the non-volatile memory. At least a portion of the storage unit 22 may be provided in the aforementioned processor, the integrated circuit, or the like. At least a portion of the storage unit 22 may be installed in a device that is connected with the vehicle 12 by means of the network 16.

The vehicle 12 includes a software updating device 24. The software updating device 24 may be configured, for example, by a CGW-ECU (Central Gateway-Electronic Control Unit). The software updating device 24 includes a computation unit 26 and a storage unit 28. The computation unit 26, for example, is a processor such as a CPU, a GPU, or the like. The computation unit 26 includes a display control unit 30, an approval confirmation unit 32, an update processing unit 34, a discard processing unit 36, a log generating unit 38, a transmission processing unit 40, and an information acquisition unit 42. The display control unit 30, the approval confirmation unit 32, the update processing unit 34, the discard processing unit 36, the log generating unit 38, the transmission processing unit 40, and the information acquisition unit 42 are realized by executing in the computation unit 26 a program that is stored in the storage unit 28. At least a portion of the display control unit 30, the approval confirmation unit 32, the update processing unit 34, the discard processing unit 36, the log generating unit 38, the transmission processing unit 40, and the information acquisition unit 42 may be realized by an integrated circuit such as an ASIC, an FPGA, or the like. At least a portion of the display control unit 30, the approval confirmation unit 32, the update processing unit 34, the discard processing unit 36, the log generating unit 38, the transmission processing unit 40, and the information acquisition unit 42 may be realized by an electronic circuit including a discrete device.

The storage unit 28 is a computer readable non-transitory tangible storage medium. The storage unit 28 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map, and the like are stored, for example, in the non-volatile memory. At least a portion of the storage unit 28 may be provided in the aforementioned processor, the integrated circuit, or the like. At least a portion of the storage unit 28 may be installed in a device that is connected with the vehicle 12 by means of the network 16.

The software updating device 24 carries out a software updating process of the ECUs 18. Downloading of the software, installation of the software, and activation of the software are included in the software updating process.

The downloading of the software indicates acquiring updating data that is transmitted from the server device 14 via the network 16, and causing the updating data to be stored in the storage unit 28 of the software updating device 24. The updating data is data that includes, for example, a program of the software after having been updated. An installer or the like may be included in the updating data.

The installation of the software indicates loading the updating data from the storage unit 28 into the ROMs of the ECUs 18. The installation of the software may be carried out by an installer. The installation of the software may be carried out by copying the updating data to the ROMs.

The activation of the software indicates a process of authenticating a license of the software that has been installed. During the activation of the software, rewriting of executable files and the like that are used by the software prior to updating thereof may be carried out. When the activation of the software is completed, execution of the software in the ECUs 18 is permitted. The activation may be carried out by the software updating device 24, or may be carried out by each of the ECUs 18.

The display control unit 30 controls a later-described IVI 48, and thereby causes later-described campaign information, downtime approval information, and the like to be displayed on a display unit 54 of the IVI 48. The approval confirmation unit 32 performs a confirmation process to confirm with the user whether or not to execute a software updating process such as downloading of the software, activation of the software, and the like. The update processing unit 34 carries out an updating process for downloading of the software, installation of the software, and activation of the software. The discard processing unit 36 carries out a discarding process to discard the acquired campaign information that is stored in the storage unit 28.

The log generating unit 38 generates a result log. In the case that the software updating process is completed, in the case that the software updating process is canceled without being completed, or in the case that the software updating process fails, the log generating unit 38 generates the result log. The log generating unit 38 may also generate an event log. In the case that a predetermined process of the software updating process is started, or alternatively, in the case that the predetermined process is completed, the event log is generated.

The transmission processing unit 40 transmits various types of information to the server device 14. The transmission processing unit 40 transmits the result log and the event log to the server device 14. The transmission processing unit 40 transmits later-described configuration synchronization information, an updating data request, and the like to the server device 14.

The information acquisition unit 42 acquires various types of information transmitted from the server device 14. The information acquisition unit 42 acquires a later-described configuration synchronization request, campaign information, updating data, and the like.

The software updating device 24 and the ECUs 18 are connected by a CAN (Controller Area Network) (registered trademark in Japan) connection and are capable of communicating mutually with each other. Moreover, the communication line that connects the software updating device 24 and the ECUs 18 is not limited to being a CAN connection, but may be an Ethernet (registered trademark in Japan) connection, or both a CAN connection and an Ethernet connection may be used. Furthermore, as the communication line, there may be used communication lines of other standards apart from a CAN connection and an Ethernet connection.

The software updating device 24 is capable of communicating with a base station 46 that is connected to the network 16 by way of cellular communication via a telematics control unit (hereinafter referred to as TCU) 44. The network 16, for example, is the Internet.

The software updating device 24 is connected to the IVI 48. The IVI 48 includes a computation unit 50 and a storage unit 52. The computation unit 50, for example, is a processor such as a CPU, a GPU, or the like.

The storage unit 52 is a computer readable non-transitory tangible storage medium. The storage unit 52 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map, and the like are stored, for example, in the non-volatile memory. At least a portion of the storage unit 52 may be provided in the aforementioned processor, the integrated circuit, or the like. At least a portion of the storage unit 52 may be installed in a device that is connected with the vehicle 12 by means of the network 16.

The IVI 48 carries out an action of providing information such as route guidance and road traffic information, as well as entertainment through an audio device, a DVD device, a TV tuner, or the like.

The IVI 48 includes the display unit 54. The display unit 54 is installed on a dashboard or the like of the vehicle 12. The display unit 54 is a touch panel display. The display unit 54, together with providing information with respect to the user in the form of images, text, and the like, accepts operational inputs from the user. The screen of the display unit 54 may be a liquid crystal display, an organic electroluminescence (organic EL) display, or the like, but is not particularly limited to this type of display. The touch panel of the display unit 54 may be a resistive type, a capacitive type, or the like, but is not particularly limited to this type. Instead of the display unit 54 being a touch panel display, a combination of a display device such as a heads-up display and a pointing device such as a motion capture device may be used.

The vehicle 12 is equipped with a Start Stop Switch (hereinafter referred to as SSSW) 56. By the user operating the SSSW 56, the power mode of the vehicle 12 is switched. The SSSW 56 corresponds to the power mode switch of the present invention. In the case that the vehicle 12 is an engine vehicle, the power mode includes IG-ON, IG-OFF, ACC-ON, ACC-OFF, and START. In the case that the vehicle 12 is a hybrid vehicle or an electric vehicle, the power mode includes IG-ON, IG-OFF, ACC-ON, ACC-OFF, and READY.

When the power mode is IG-ON, all of the electrical equipment of the vehicle 12 can be used. When the power mode is ACC-ON, a portion of the electrical equipment such as the audio device or the like can be used. When the power mode is ACC-OFF, except for a portion of the electrical equipment such as a keyless entry system or the like, none of the electrical equipment can be used. Any state other than IG-ON is IG-OFF, and in the power mode IG-OFF, there is included ACC-ON and ACC-OFF. The number of electrical components that are capable of being operated when the power mode is OFF is smaller than the number of electrical components that are capable of being operated when the power mode IG-ON. IG-ON corresponds to a first mode of the present invention, and IG-OFF corresponds to a second mode of the present invention. The number of electrical components that are operable when the power mode is IG-ON corresponds to a first number, and the number of electrical components that are capable of being operated when the power mode is IG-OFF corresponds to a second number.

In the START mode, the starter motor is driven to start the engine. After the engine has been started, the power mode transitions to the IG-ON mode. In the READY mode, the drive motor is capable of being driven, and the vehicle 12 can be driven by the drive motor. At a time when the hybrid vehicle and the electric vehicle are capable of being driven, the power modes are IG-ON, and in addition, READY.

The vehicle 12 is equipped with a shift position sensor 58. The shift position sensor 58 detects the selected shift position. A parking position (P position), a neutral position (N position), a drive position (D position), a reverse position (R position), and the like, are capable of being selected as the shift position.

The server device 14 includes a computation unit 60 and a storage unit 62. The computation unit 60, for example, is a processor such as a CPU, a GPU, or the like. The computation unit 60 includes a transmission processing unit 64 and an information acquisition unit 66. The transmission processing unit 64 and the information acquisition unit 66 are realized by executing in the computation unit 60 a program that is stored in the storage unit 62. At least a portion of the transmission processing unit 64 and the information acquisition unit 66 may be realized by an integrated circuit such as an ASIC, an FPGA, or the like. At least a portion of the transmission processing unit 64 and the information acquisition unit 66 may be realized by an electronic circuit including a discrete device.

The storage unit 62 is a computer readable non-transitory tangible storage medium. The storage unit 62 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map, and the like are stored, for example, in the non-volatile memory. At least a portion of the storage unit 62 may be provided in the aforementioned processor, the integrated circuit, or the like. At least a portion of the storage unit 62 may be installed in a device that is connected with the server device 14 by means of the network 16.

A plurality of the vehicles 12 are registered in the server device 14, and the server device manages an updated state of the software of the ECUs 18 of each of the vehicles 12. The server device 14 provides to each of the vehicles 12 the updating data for updating the software of the ECUs 18 of each of the vehicles 12.

The transmission processing unit 64 transmits various types of information to the vehicle 12. The transmission processing unit 64 transmits to the vehicle 12 a later-described configuration synchronization request, campaign information, updating data, and the like. The information acquisition unit 66 acquires various types of information transmitted from the vehicle 12. The information acquisition unit 66 acquires the result log and the event log. The information acquisition unit 66 acquires later-described configuration synchronization information, an updating data request, and the like.

### Flow of Software Updating Process

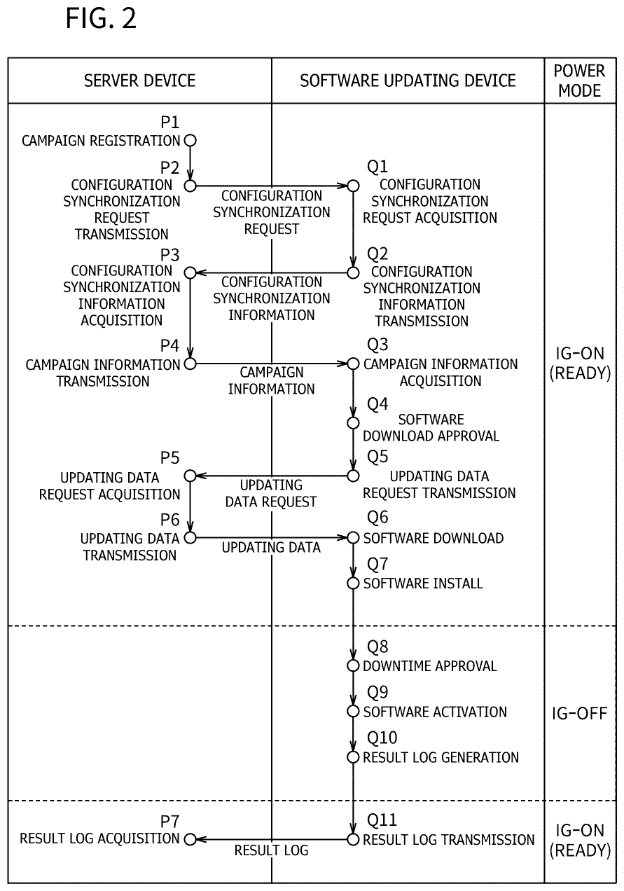

FIG. 2 is a flow diagram of the software updating process according to the one embodiment.

After a campaign has been registered in the server device 14 (P1), the vehicle 12 issues a command request with respect to the server device 14. If a campaign is registered in the server device 14, the transmission processing unit 64 of the server device 14 transmits a configuration synchronization request to the software updating device 24 of the vehicle 12 (P2). The campaign, together with the updating data for updating the software of the ECUs 18, is registered in the server device 14 by a software developer of software for the ECUs 18, and a make of the vehicle 12, and the like.

When the information acquisition unit 42 of the software updating device 24 acquires the configuration synchronization request (Q1), the transmission processing unit 40 transmits the configuration synchronization information to the server device 14 (Q2). Information of a unique identifier assigned to each of the ECUs 18 of the vehicle 12, information of the software version of each of the ECUs 18, and the like are included in the configuration synchronization information.

The transmission of the configuration synchronization information to the server device 14 by the transmission processing unit 40 is not limited to the case, as described previously, in which the information acquisition unit 42 of the software updating device 24 acquires the configuration synchronization request transmitted from the server device 14. For example, in the case that a configuration synchronization has been instructed by the user via the IVI 48 or the like, the transmission processing unit 40 may transmit the configuration synchronization information to the server device 14. Further, the transmission processing unit 40 may periodically transmit the configuration synchronization information to the server device 14.

When the information acquisition unit 66 of the server device 14 acquires the configuration synchronization information (P3), the transmission processing unit 64 transmits campaign information concerning the software updating process of each of the ECUs 18 to the software updating device 24 (P4).

The information acquisition unit 42 of the software updating device 24 acquires the campaign information (Q3) and stores the campaign information in the storage unit 28. The display control unit 30 causes the display unit 54 of the IVI 48 to display the campaign information. A confirmation process to confirm with the user whether or not to approve the downloading of the software is carried out by the approval confirmation unit 32. In this confirmation process, when the user approves the downloading of the software (Q4), the transmission processing unit 40 of the software updating device 24 transmits an updating data request to the server device 14 (Q5).

When the information acquisition unit 66 of the server device 14 acquires the updating data request (P5), the transmission processing unit 64 transmits the updating data to the software updating device 24 (P6).

The information acquisition unit 42 of the software updating device 24 acquires the updating data, and the update processing unit 34 causes the updating data to be stored in the storage unit 28, whereby the software is downloaded (Q6). Thereafter, the update processing unit 34 loads the updating data from the storage unit 28 into the ROMs of the ECUs 18, and thereby installs the software (Q7) in the ECUs 18.

Prior to the activation of the software being started, the approval confirmation unit 32 of the software updating device 24 carries out a confirmation process to confirm with the user whether or not to approve the downtime. At a point in time at which the power mode transitions from IG-ON (or READY) to IG-OFF, in the case that the shift position detected by the shift position sensor 58 is “P,” the confirmation process is executed. In this confirmation process, when the user approves the downtime (Q8), the update processing unit 34 of the software updating device 24 (Q9) carries out the activation of the software of the ECUs 18. The downtime refers to a period of time in which while the activation of the software is being carried out, the power mode of the vehicle 12 cannot be set to the START mode or the READY mode, and travelling of the vehicle 12 cannot be started.

When the activation of the software in the ECUs 18 is completed, the log generating unit 38 of the software updating device 24 generates the result log (Q10). Once the result log is generated, the software updating device 24 shuts down.

When the power mode transitions from IG-OFF to IG-ON (or READY), the software updating device 24 is started. After the software updating device 24 is activated, the transmission processing unit 40 transmits a result log to the server device 14 (Q11).

When the information acquisition unit 66 of the server device 14 acquires the result log (P7), the series of updating of the software comes to an end.

### Transmission Control

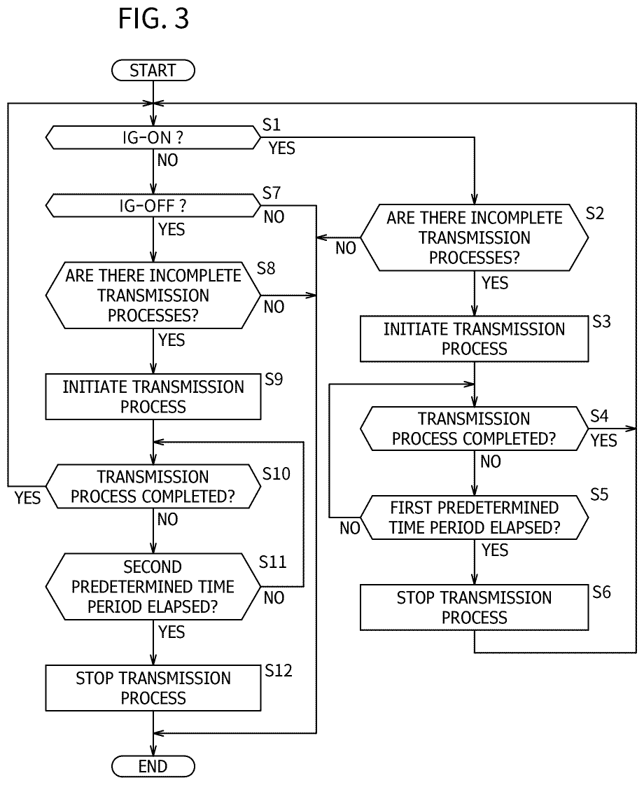

FIG. 3 is a flowchart showing a transmission control carried out by the software updating device 24 according to the one embodiment. The transmission control is executed at a predetermined cycle while the software updating device 24 is activated. In the transmission control, a plurality of transmission processes are carried out sequentially.

In step S1, the transmission processing unit 40 determines whether or not the power mode of the vehicle 12 is IG-ON. In the case it is determined that the power mode is IG-ON (step S1: YES), the process transitions to step S2.

In step S2, the transmission processing unit 40 determines whether or not there are any incomplete transmission processes. In the case it is determined that there is an incomplete transmission process (step S2: YES), the process transitions to step S3. In the case it is determined that there is not an incomplete transmission process (step S2: NO), the transmission control comes to an end.

In step S3, the transmission processing unit 40 initiates the transmission process. Thereafter, the process transitions to step S4.

In step S4, the transmission processing unit 40 determines whether or not the transmission process is completed. In the case it is determined that the transmission process is completed (step S4: YES), the process returns to step S1. In the case it is determined that the transmission process is not completed (step S4: NO), the process transitions to step S5.

In step S5, the transmission processing unit 40 determines whether or not a first predetermined time period has elapsed from a point in time at which the transmission process was started. In step S5, in the case that the first predetermined time period has elapsed from the point in time at which the transmission process was started, the transmission processing unit 40 determines that the transmission process has timed out. In the case it is determined that the transmission process has timed out (step S5: YES), the process transitions to step S6. In the case it is determined that the transmission process has not timed out (step S5: NO), the process returns to step S4. In the case that the transmission process is not successful, the transmission processing unit 40 performs a transmission retry to carry out the transmission process again. In the case that the power mode of the vehicle 12 is IG-ON, the transmission retry is repeatedly carried out until the transmission process is successful, or alternatively, until the first predetermined time period has elapsed from the point in time at which the transmission process was started.

In step S6, the transmission processing unit 40 stops the transmission process that is currently being executed. Thereafter, the process returns to step S1.

In the aforementioned step S1, in the case it is determined that the power mode is not IG-ON (step S1: NO), the process transitions to step S7. In step S7, the transmission processing unit 40 determines whether or not the power mode of the vehicle 12 is IG-OFF. In the case it is determined that the power mode is IG-OFF (step S7: YES), the process transitions to step S8. In the case it is determined that the power mode is not IG-OFF (step S7: NO), the transmission control comes to an end.

In step S8, the transmission processing unit 40 determines whether or not there are any incomplete transmission processes. In the case it is determined that there is an incomplete transmission process (step S8: YES), the process transitions to step S9. In the case it is determined that there is not an incomplete transmission process (step S8: NO), the transmission control comes to an end.

In step S9, the transmission processing unit 40 initiates the transmission process. Thereafter, the process transitions to step S10.

In step S10, the transmission processing unit 40 determines whether or not the transmission processes are completed. In the case it is determined that the transmission processes are completed (step S10: YES), the process returns to step S1. In the case it is determined that the transmission processes are not completed (step S10: NO), the process transitions to step S11.

In step S11, the transmission processing unit 40 determines whether or not a second predetermined time period has elapsed from a point in time at which the transmission process was started. The second predetermined time period is set to be shorter than the first predetermined time period. In step S11, in the case that the second predetermined time period has elapsed from the point in time at which the transmission process was started, the transmission processing unit 40 determines that the transmission process has timed out. In the case it is determined that the transmission process has timed out (step S11: YES), the process transitions to step S12. In the case it is determined that the transmission process has not timed out (step S11: NO), the process returns to step S10. In the case that the transmission process is not successful, the transmission processing unit 40 performs a transmission retry to carry out the transmission process again. In the case that the power mode of the vehicle 12 is IG-OFF, the transmission retry is repeatedly carried out until the transmission process is successful, or alternatively, until the second predetermined time period has elapsed from the point in time at which the transmission process was started.

In step S12, the transmission processing unit 40 stops the transmission process that is currently being executed. Thereafter, the transmission control comes to an end.

In the aforementioned transmission control, in the case that the power mode of the vehicle 12 is IG-ON, and further, the transmission process has timed out, the transmission process that is currently being executed is stopped, and another transmission process is newly executed. On the other hand, in the case that the power mode is IG-OFF, and further, the transmission process has timed out, the transmission process that is currently being executed is stopped, and another transmission process is not newly executed.

During the period in which the power mode of the vehicle 12 is IG-OFF, the vehicle 12 is considered to be parked and not moving. Therefore, in the case that the communication condition at the parking location is unsatisfactory and the transmission process cannot be completed, even if another transmission process is executed, there is a high possibility that the other transmission process will not be completed either. Therefore, in the aforementioned transmission control, in the case that the power mode is IG-OFF, after having timed out without the transmission process being completed, the other transmission process is not executed.

### Software Updating Control

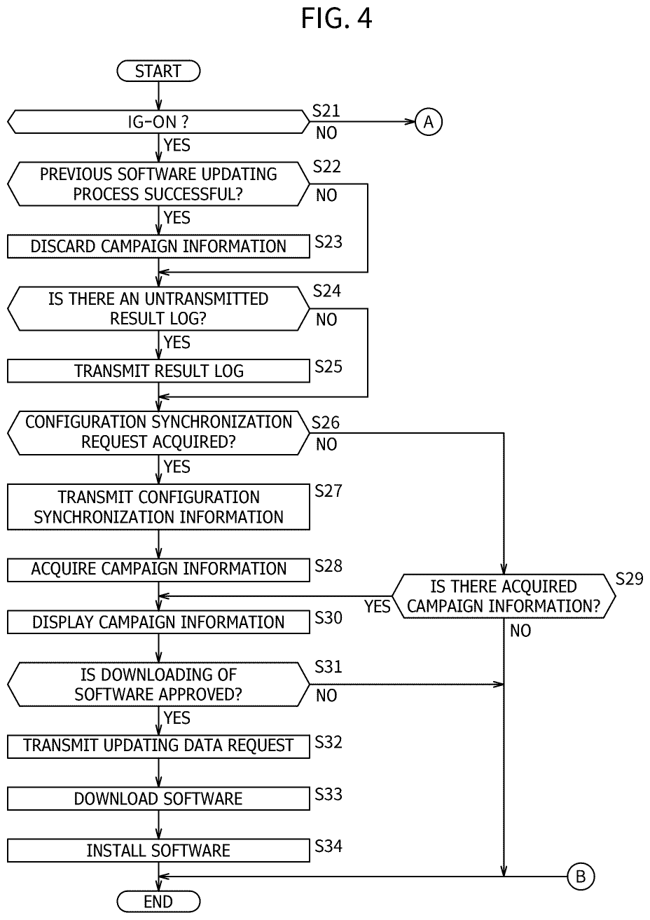

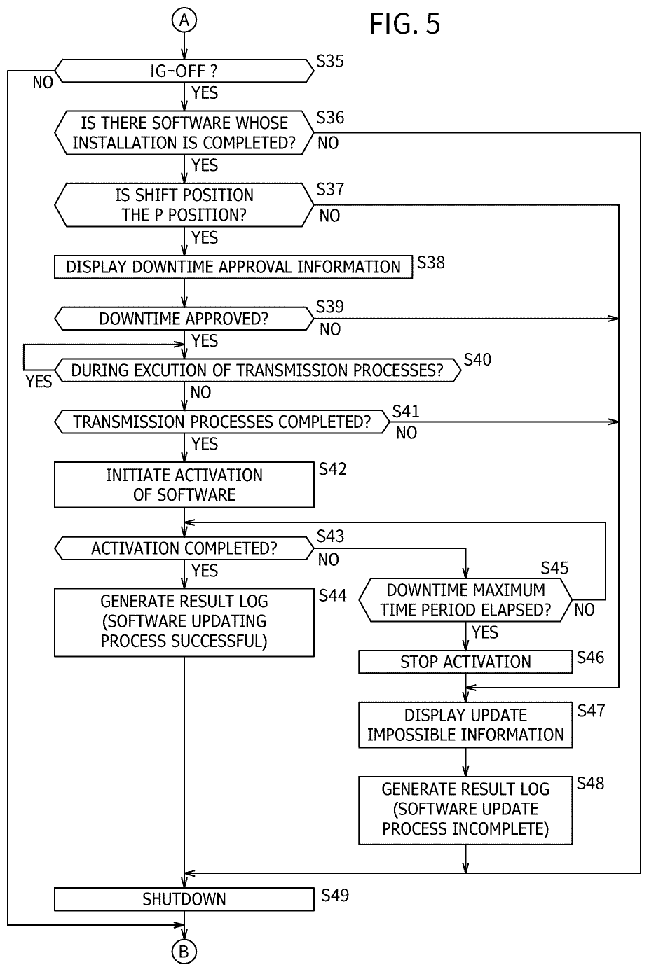

FIG. 4 and FIG. 5 are flowcharts showing the software updating control carried out by the software updating device 24 according to the one embodiment. The software updating control is executed at a predetermined cycle while the software updating device 24 is activated.

In step S21, the transmission processing unit 40 of the software updating device 24 determines whether or not the power mode of the vehicle 12 is IG-ON. In the case it is determined that the power mode is IG-ON (step S21: YES), the process transitions to step S22.

In step S22, the discard processing unit 36 of the software updating device 24 determines whether or not the previous software updating process was successful. In the case it is determined that the previous software updating process was successful (step S22: YES), the process transitions to step S23. In the case it is determined that the previous software updating process was not successful (step S22: NO), the process transitions to step S24.

In step S23, the discard processing unit 36 of the software updating device 24 discards the campaign information that is stored in the storage unit 28. Thereafter, the process transitions to step S24.

In step S24, the transmission processing unit 40 of the software updating device 24 determines whether or not there is an untransmitted result log. In the case it is determined that there is an untransmitted result log (step S24: YES), the process transitions to step S25. In the case it is determined that there is not an untransmitted result log (step S24: NO), the process transitions to step S26.

In step S25, the transmission processing unit 40 of the software updating device 24 transmits the result log to the server device 14. Thereafter, the process transitions to step S26.

In step S26, the information acquisition unit 42 of the software updating device 24 determines whether or not a configuration synchronization request has been acquired from the server device 14. In the case it is determined that the configuration synchronization request has been acquired (step S26: YES), the process transitions to step S27.

In step S27, the transmission processing unit 40 of the software updating device 24 transmits the configuration synchronization information to the server device 14. Thereafter, the process transitions to step S28.

In step S28, the information acquisition unit 42 of the software updating device 24 acquires the campaign information and stores the campaign information in the storage unit 28.

In the aforementioned step S26, in the case it is determined that the configuration synchronization request has not been acquired (step S26: NO), the process transitions to step S29. In step S29, the software updating device 24 determines whether or not there is acquired campaign information in the storage unit 28. In the case it is determined that there is no acquired campaign information in the storage unit 28 (step S29: NO), the software updating control comes to an end.

After the process of the aforementioned step S28 is completed, or alternatively, in the aforementioned step S29, in the case it is determined that there is acquired campaign information in the storage unit 28 (step S29: YES), the process transitions to step S30. In step S30, the display control unit 30 of the software updating device 24 causes the campaign information to be displayed on the display unit 54 of the IVI 48. Thereafter, the process transitions to step S31.

In step S31, the approval confirmation unit 32 of the software updating device 24 determines whether or not the downloading of the software has been approved by the user. In the case it is determined that the downloading of the software has been approved (step S31: YES), the process transitions to step S32. In the case it is determined that the downloading of the software has not been approved (step S31: NO), the software updating control comes to an end.

In step S32, the transmission processing unit 40 of the software updating device 24 transmits an updating data request to the server device 14. Thereafter, the process transitions to step S33.

In step S33, the update processing unit 34 of the software updating device 24 downloads the software. Thereafter, the process transitions to step S34.

In step S34, the update processing unit 34 of the software updating device 24 installs the software. Thereafter, the software updating process comes to an end.

In the aforementioned step S21, in the case it is determined that the power mode of the vehicle 12 is not IG-ON (step S21: NO), the process transitions to step S35.

In step S35, the update processing unit 34 of the software updating device 24 determines whether or not the power mode of the vehicle 12 is IG-OFF. In the case it is determined that the power mode is IG-OFF (step S35: YES), the process transitions to step S36. In the case it is determined that the power mode is not IG-OFF (step S35: NO), the software updating process comes to an end.

In step S36, the update processing unit 34 of the software updating device 24 determines whether or not there is any software for which the installation thereof is completed. In the case it is determined that there is software for which the installation thereof is completed (step S36: YES), the process transitions to step S37.

In step S37, the update processing unit 34 of the software updating device 24 determines whether or not the shift position is the P position. In the case it is determined that the shift position is the P position (step S37: YES), the process transitions to step S38.

In step S38, the display control unit 30 of the software updating device 24 causes the downtime approval information to be displayed on the display unit 54 of the IVI 48. Thereafter, the process transitions to step S39.

In step S39, the approval confirmation unit 32 of the software updating device 24 determines whether or not the downtime has been approved by the user. In the case it is determined that the downtime has been approved (step S39: YES), the process transitions to step S40.

In step S40, the update processing unit 34 of the software updating device 24 determines whether or not a transmission process is currently being executed. In the case it is determined that a transmission process is currently being executed (step S40: YES), the process of step S40 is repeated. In the case it is determined that a transmission process is not currently being executed (step S40: NO), the process transitions to step S41.

In step S41, the update processing unit 34 of the software updating device 24 determines whether or not the transmission processes have been completed. In the case it is determined that the transmission processes have been completed (step S41: YES), the process returns to step S42.

In step S42, the update processing unit 34 of the software updating device 24 initiates the activation of the software. Thereafter, the process transitions to step S43.

In step S43, the update processing unit 34 of the software updating device 24 determines whether or not the activation of the software has been completed. In the case it is determined that the activation of the software has been completed (step S43: YES), the process transitions to step S44.

In step S44, the log generating unit 38 of the software updating device 24 generates the result log. Thereafter, the process transitions to step S49. In the result log that is generated in step S44, there is included information indicating that the software updating process was successful.

In step S43, in the case it is determined that the activation of the software is not completed (step S43: NO), the process transitions to step S45. In step S45, the update processing unit 34 of the software updating device 24 determines whether or not a downtime maximum time period has elapsed from the point in time it was determined in step S39 that the downtime was approved. In the case that the downtime maximum time period has elapsed from the point in time it was determined that the downtime was approved, the update processing unit 34 determines that the activation has timed out. In the case it is determined that the activation has timed out (step S45: YES), the process transitions to step S46. In the case it is determined that the activation has not timed out (step S45: NO), the process returns to step S43.

In step S46, the update processing unit 34 of the software updating device 24 stops the activation of the software. Thereafter, the process transitions to step S47.

In the aforementioned step S37, in the case it is determined that the shift position is not the P position (step S37: NO), or alternatively, in the aforementioned step S39, in the case it is determined that the downtime has not been approved (step S39: NO), or alternatively, in the aforementioned step S41, in the case it is determined that the transmission processes have not been completed (step S41: NO), or alternatively, after the process of the aforementioned step S46 has been completed, the process transitions to step S47. In step S47, the display control unit 30 of the software updating device 24 causes update impossible information, which indicates that the updating of the software is impossible, to be displayed on the display unit 54. Thereafter, the process transitions to step S48.

In step S48, the log generating unit 38 of the software updating device 24 generates the result log. In the result log that is generated in step S48, there is included information indicating that the software updating process is incomplete.

In the case it is determined in step S36 that there is not software for which the installation thereof has been completed (step S36: NO), or alternatively, after the process of step S44 has been completed, or alternatively, after the process of step S48 has been completed, the process transitions to step S49. In step S49, the software updating device 24 shuts down. Thereafter, the software updating process comes to an end. Once the software updating device 24 is shut down, the software updating device 24 will not be activated until the power mode of the vehicle 12 is set to IG-ON.

### Concerning Operations of the Software Updating Device

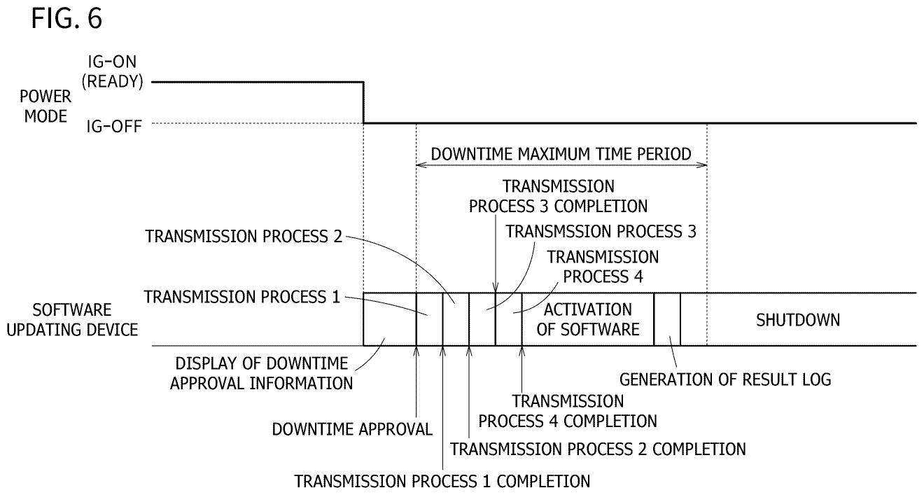

FIG. 6 to FIG. 8 are diagrams for providing a description of the operations of the software updating device 24. FIG. 6 to FIG. 8 show the operations of the software updating device 24, after the installation of the software has been completed, and during a period including a point in time at which the vehicle 12 is parked and the power mode of the vehicle 12 has transitioned from IG-ON to IG-OFF.

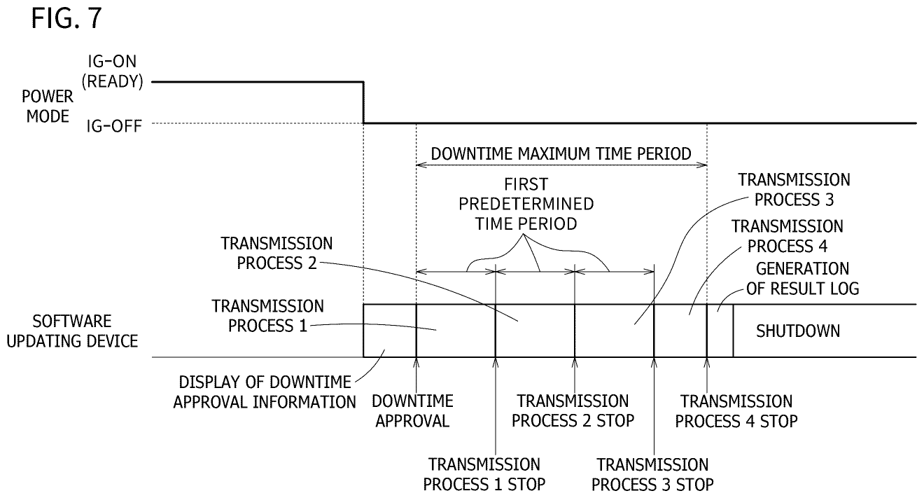

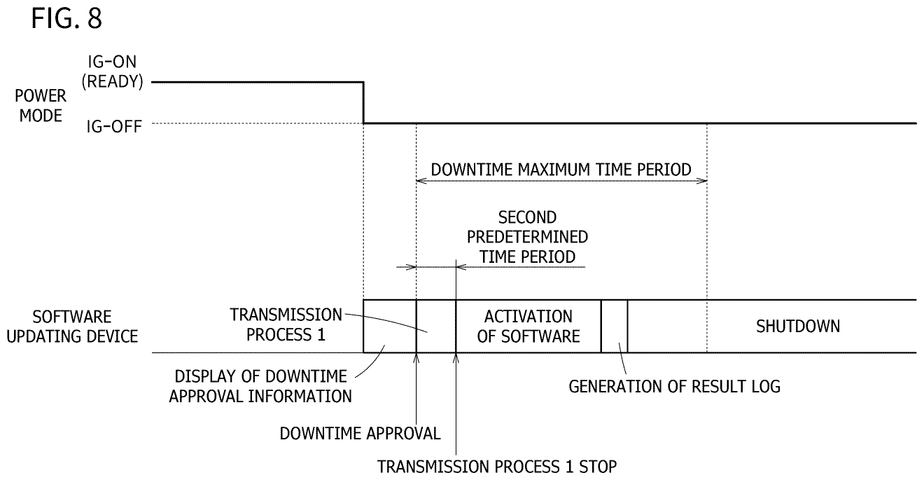

FIG. 6 shows operations of the software updating device 24 in the case that the communication condition at a location where the vehicle is parked is satisfactory. FIG. 7 shows operations of the software updating device 24 in the case that the communication condition at a location where the vehicle is parked is not satisfactory. FIG. 8 shows operations of the software updating device 24 of the one embodiment in the case that the communication condition at a location where the vehicle is parked is not satisfactory.

In the case that the power mode of the vehicle 12 has transitioned from IG-ON to IG-OFF, the downtime approval information is displayed on the display unit 54 of the IVI 48. In the case that the downtime has been approved by the user, a transmission process is carried out in which an event log or the like containing information indicating that the approval of the downtime has been obtained is transmitted to the server device 14. In the example shown in FIG. 6 to FIG. 8, four of the transmission processes are carried out in sequence. In the case that the communication condition is satisfactory (FIG. 6), the software is activated after these transmission processes have been completed.

In the case that the transmission condition at the location where the vehicle is parked is not satisfactory and a transmission process fails, the transmission processing unit 40 performs a transmission retry to carry out the transmission process again. Conventionally, in the case that the power mode of the vehicle 12 is IG-OFF, the transmission retry is repeatedly carried out until the transmission process is successful, or alternatively, until the first predetermined time period has elapsed from the point in time at which the transmission process was started.

In the case that the transmission processes are not completed within the first predetermined time period, the transmission process that is currently being executed (for example, the “Transmission Process 1” in FIG. 7) is stopped, and another transmission process (for example, the “Transmission Process 2” in FIG. 7) is executed. The possibility of the communication condition improving in a short period of time while the vehicle is parked is low, and the possibility of the other transmission process not being completed within the first predetermined time period is high. Therefore, the transmission retry is repeated for each of the plurality of transmission processes, and even if the approval of the activation of the software by the user has been obtained, there is a concern that the downtime maximum time period may elapse without the activation of the software being attained. Furthermore, conventionally, the transmission retries are repeated for a comparatively long period of time, and there is a concern that the downtime maximum time period may elapse without the activation of the software being attained.

Thus, in the one embodiment, in the case that the power mode of the vehicle 12 is IG-OFF, then in the case that the transmission process is not completed within the second predetermined time period, the transmission process that is currently being executed is stopped, and no other transmission processes are executed. For example, as shown in FIG. 8, in the case that the “Transmission Process 1” is not completed within the second predetermined time period, the “Transmission Process 1” that is currently being executed is stopped, and the “Transmission Process 2” that is the other transmission process is not executed.

Further, in the one embodiment, the maximum time period (the second predetermined time period) for which the transmission retries are repeated in the case that the power mode of the vehicle 12 is the IG-OFF mode is set to be shorter than the maximum time period (the first predetermined time period) for which the transmission retries are repeated in the case that the power mode is the IG-ON mode.

In accordance with this feature, a situation is suppressed in which the transmission processes continue for a long time period in the case that the power mode of the vehicle 12 is IG-OFF and further the communication state is not satisfactory, and thus it is possible for the activation to be completed within the downtime maximum time period.

### Other Embodiments

The software updating system 10 of the above-described embodiment may be modified in the following manner.

In the case that the transmission process has timed out due to the communication condition being unsatisfactory, the update processing unit 34 may activate the software without waiting for the transmission process to be completed.

In the case that the transmission process has timed out due to the communication condition being unsatisfactory, the transmission processing unit 40 may stop the transmission process. In this case, in response to the transmission process by the transmission processing unit 40 being stopped, the update processing unit 34 executes the activation of the software.

In response to the power mode of the vehicle 12 being IG-OFF and further all of the plurality of transmission processes having been completed without the timeout, the update processing unit 34 may execute the activation of the software.

In the case that the power mode of the vehicle 12 is IG-OFF and further any one of the plurality of transmission processes has timed out, the update processing unit 34 may execute the activation of the software without waiting for the plurality of transmission processes to be completed.

In the case that the transmission processing unit 40 has stopped the transmission process, the transmission processing unit 40 may resume, after the software update has been completed, the transmission process that was stopped. Further, in the case that the transmission processing unit 40 has stopped the transmission process, the transmission processing unit 40 may resume, after the power mode of the vehicle 12 has transitioned from IG-OFF to IG-ON, the transmission process that was stopped.

Concerning the above-described embodiments, the following supplementary notes are further disclosed.

### Supplementary Note 1

The software updating system (10) of the present disclosure includes the vehicle (12) and the server device (14) configured to communicate with the vehicle via the network (16), the software updating system including the transmission processing unit (40) configured to execute the transmission process for carrying out the transmission of data to the server device, and the update processing unit (34) configured to execute, in response to completion of the transmission process by the transmission processing unit, the software updating process for the electronic control unit that is provided in the vehicle, wherein in the case that the transmission process times out due to the communication condition being unsatisfactory, the update processing unit executes the software updating process without waiting for the completion of the transmission process. In accordance with such a configuration, a situation is suppressed in which the transmission process continues for a long time in the case that the communication state is not satisfactory, and thus it is possible for the software updating process to be completed.

### Supplementary Note 2

In the software updating system according to Supplementary Note 1, the data may include information indicating that the user has approved the software updating process.

### Supplementary Note 3

In the software updating system according to Supplementary Note 1, in the case that the transmission process times out due to the communication condition being unsatisfactory, the transmission process may be stopped and in response to stopping of the transmission process, the software updating process may be executed.

### Supplementary Note 4

In the software updating system according to Supplementary Note 3, in the case that the transmission process is stopped, after the software updating process is completed, the transmission process may be resumed.

### Supplementary Note 5

In the software updating system according to Supplementary Note 1, the software updating process may be a process for carrying out activation of software that is installed in the electronic control unit.

### Supplementary Note 6

In the software updating system comprising the vehicle, and the server configured to communicate with the vehicle via the network, the software updating system comprises the power mode switch (56) configured to switch the power mode of the vehicle based on the operation made by the user to at least one of the first mode in which the first number of electrical components from among the plurality of electrical components mounted on the vehicle are capable of operating, and the second mode in which the second number of electrical components that is smaller than the first number are capable of operating, the transmission processing unit that sequentially executes the plurality of transmission processes for carrying out the transmission of data to the server device, and the update processing unit that executes the software updating process for the electronic control unit that is provided in the vehicle, wherein, in response to the power mode being the second mode and further all of the plurality of transmission processes being completed without the timeout, the update processing unit executes the software updating process, and in the case that the power mode is the second mode and further any one of the plurality of transmission processes times out, the update processing unit executes the software updating process without waiting for the transmission processing unit to complete all of the plurality of transmission processes.

### Supplementary Note 7

In the software updating system according to Supplementary Note 6, the data may include information indicating that the user has approved the software updating process.

### Supplementary Note 8

In the software updating system according to Supplementary Note 6, the software updating process may be a process for carrying out activation of the software that is installed in the electronic control unit.

### Supplementary Note 9

The software updating device (24) according to the present disclosure is the software updating device in the software updating system according to any one of Supplementary Notes 1 to 8, including the transmission processing unit and the update processing unit.

### Supplementary Note 10

In the software updating method for carrying out the software updating process for the electronic control unit that is provided in a vehicle, the software updating method comprises the transmission processing step of executing the transmission process for carrying out transmission of the data to the server device configured to communicate via the network, and the update processing step of executing the software updating process in response to completion of the transmission process, wherein in the case that the transmission process times out due to the communication condition being unsatisfactory, the software updating process is executed in the update processing step without waiting for the completion of the transmission process.

### Supplementary Note 11

In the software updating method according to Supplementary Note 10, the data may include information indicating that the user has approved the software updating process.

### Supplementary Note 12

In the software updating method according to Supplementary Note 10, in the case that the transmission process times out due to the communication condition being unsatisfactory, the transmission process may stop and in response to stopping of the transmission process, the software updating process may be executed.

### Supplementary Note 13

In the software updating system according to Supplementary Note 12, there may further be provided the retransmission processing step which, in the case that the transmission process is stopped, the transmission process may be resumed after the software updating process is completed.

### Supplementary Note 14

In the software updating method according to Supplementary Note 10, the software updating process may be a process for carrying out activation of the software that is installed in the electronic control unit.

### Supplementary Note 15

The program of the present disclosure causes the computer to execute the software updating method according to any one of Supplementary Notes 10 to 14.

### Supplementary Note 16

The computer readable non-transitory storage medium according to the present disclosure stores the program according to Supplementary Note 15.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A software updating system comprising a vehicle, and a server device configured to communicate with the vehicle via a network, the software updating system comprising:
one or more processors that execute computer-executable instructions stored in a memory;
wherein, the one or more processors execute the computer executable-instructions to cause the software updating system to:
execute a transmission process to carry out transmission of data to the server device;
execute, upon completion of the transmission process, a software updating process for an electronic control unit that is provided in the vehicle; and
execute the software updating process without waiting for the completion of the transmission process in the case that the transmission process times out due to a communication condition being unsatisfactory.

2. The software updating system according to claim 1, wherein the data includes information indicating that a user has approved the software updating process.

3. The software updating system according to claim 1, wherein:
in the case that the transmission process times out due to the communication condition being unsatisfactory, the transmission process is stopped; and
in response to stopping of the transmission process, the software updating process is executed.

4. The software updating system according to claim 3, wherein, in the case that the transmission process is stopped, after the software updating process is completed, the transmission process is resumed.

5. The software updating system according to claim 1, wherein the software updating process is a process for carrying out activation of software that is installed in the electronic control unit.

6. A software updating system comprising a vehicle, and a server device configured to communicate with the vehicle via a network, the software updating system comprising:
a power mode switch configured to switch a power mode of the vehicle based on an operation made by a user to at least one of a first mode in which a first number of electrical components from among a plurality of electrical components mounted on the vehicle are capable of operating, and a second mode in which a second number of electrical components that is smaller than the first number are capable of operating; and
one or more processors that execute computer-executable instructions stored in a memory;
wherein the one or more processors execute the computer-executable instructions to cause the software updating system to:
sequentially execute a plurality of transmission processes for carrying out transmission of data to the server device;
execute a software updating process for an electronic control unit that is provided in the vehicle;
execute the software updating process in response to the power mode being the second mode and further all of the plurality of transmission processes being completed without a timeout; and
execute the software updating process without waiting for completion of all of the plurality of transmission processes in the case that the power mode is the second mode and further any one of the plurality of transmission processes times out.

7. The software updating system according to claim 6, wherein the data includes information indicating that a user has approved the software updating process.

8. The software updating system according to claim 6, wherein the software updating process is a process for carrying out activation of software that is installed in the electronic control unit.

9. A software updating device in the software updating system according to claim 1, the software updating device comprising
one or more processors that execute computer-executable instructions stored in a memory,
wherein the one or more processors execute the computer-executable instructions to cause the software updating system to:
execute a transmission process for carrying out transmission of data to the server device;
execute, in response to completion of the transmission process, a software updating process for an electronic control unit that is provided in the vehicle; and
execute the software updating process without waiting for the completion of the transmission process in the case that the transmission process times out due to a communication condition being unsatisfactory.

10. A software updating method for carrying out a software updating process for an electronic control unit that is provided in a vehicle, the software updating method comprising:
a transmission processing step of executing a transmission process for carrying out transmission of data to a server device configured to communicate via a network; and
an update processing step of executing the software updating process in response to completion of the transmission process;
wherein in the case that the transmission process times out due to a communication condition being unsatisfactory, the software updating process in the update processing step is executed without waiting for the completion of the transmission process.

11. The software updating method according to claim 10, wherein the data includes information indicating that a user has approved the software updating process.

12. The software updating method according to claim 10, wherein:
in the case that the transmission process times out due to the communication condition being unsatisfactory, the transmission process in the transmission processing step is stopped; and
in response to stopping of the transmission process, the software updating process in the update processing step is executed.

13. The software updating method according to claim 12, further comprising a retransmission processing step which, in the case that the transmission process is stopped, the transmission process is resumed after the software updating process is completed.

14. The software updating method according to claim 10, wherein the software updating process is a process for carrying out activation of software that is installed in the electronic control unit.

15. A computer readable non-transitory storage medium storing a program for causing a computer to execute the software updating method according to claim 10.
